(19) United States
(12) Patent Application Publication
(10) Pub. No.: US 2015/0284933 A1
(43) Pub. Date: Oct. 8, 2015

(54) ELECTRO HYDRAULIC ACTUATOR MOUNTING STRUCTURE FOR HYBRID TYPE CONSTRUCTION MACHINE

(71) Applicant: VOLVO CONSTRUCTION EQUIPMENT AB, Eskilstuna (SE)

(72) Inventors: Jai-Wook Shin, Gimhae-si (KR); Hoon Kim, Changwon-si (KR)

(21) Appl. No.: 14/437,468

(22) PCT Filed: Oct. 29, 2012
(86) PCT No.: PCT/KR2012/008941

§ 371 Date: Apr. 21, 2015

(51) Int. Cl. E02F 9/08; F15B 15/18; E02F 3/42

(52) U.S. Cl. CPC E02F 9/0858; E02F 3/42; F15B 15/18; F15B 2211/20515

(57) ABSTRACT

An electro hydraulic actuator mounting structure for a hybrid construction machine is disclosed, which is configured to vertically mount electro hydraulic actuators that can control a boom, an arm, and a bucket using electric energy on an upper frame. The electro hydraulic actuator mounting structure for a hybrid construction machine includes electro hydraulic actuators for a boom, an arm, and a bucket, which include electric motors for the boom, the arm, and the bucket, that are driven by electric energy generated by a generator that is connected to an engine, and a plurality of hydraulic pumps connected to the respective electric motors for the boom, the arm, and the bucket, wherein the electro hydraulic actuators for the boom, the arm, and the bucket are vertically arranged and fixed to a pillar frame installed on an upper frame.

### TECHNICAL FIELD

The present invention relates to an electro hydraulic actuator mounting structure for a hybrid construction machine, and more particularly to an electro hydraulic actuator mounting structure for a hybrid construction machine, which is configured to vertically mount electro hydraulic actuators that can control a boom, an arm, and a bucket using electric energy on an upper frame.

Hereinafter, it is assumed that the electro hydraulic actuator (EHA) includes electric motors for a boom, an arm, and a bucket, which are driven by electric energy that is generated by a generator connected to an engine and is charged in a charging device, and a plurality of hydraulic pumps which are respectively driven by the electric motors to supply hydraulic fluid to a boom cylinder and the like.

### BACKGROUND OF THE INVENTION

In general, a hydraulic excavator may drive a working device, such as a boom, in a manner that hydraulic pumps are driven by an engine, and a spool of a main control valve (MCV) is controlled by pilot signal pressure to control a flow rate of hydraulic fluid that is supplied from the hydraulic pumps to hydraulic actuators.

On the other hand, a hybrid excavator may drive a working device, such as a boom, in a manner that electric energy that is generated by a generator that is driven by an engine is charged in a battery, and electric motors are driven by the electric energy that is supplied from the battery to drive hydraulic pumps. The hybrid excavator requires a separate mounting structure for mounting electro hydraulic actuators, each of which is composed of the electric motors and the hydraulic pumps, on an upper frame.

### SUMMARY OF THE INVENTION

Accordingly, the present invention has been made to solve the aforementioned problems occurring in the prior art, and it is an object of the present invention to provide an electro hydraulic actuator mounting structure for a hybrid construction machine, which can vertically mount electro hydraulic actuators on an upper frame to minimize an occupied space and can stably mount the electro hydraulic actuators on the upper frame.

It is another object of the present invention to provide an electro hydraulic actuator mounting structure for a hybrid construction machine, which can minimize electric noise from occurring due to high-voltage cables that connect the electro hydraulic actuators and converters to each other.

### TECHNICAL SOLUTION

To achieve the above objects, in accordance with an embodiment of the present invention, there is provided an electro hydraulic actuator mounting structure for a hybrid construction machine, which includes electro hydraulic actuators for a boom, an arm, and a bucket, which include electric motors for the boom, the arm, and the bucket, that are driven by electric energy generated by a generator that is connected to an engine, and a plurality of hydraulic pumps connected to the respective electric motors for the boom, the arm, and the bucket, wherein the electro hydraulic actuators for the boom, the arm, and the bucket are vertically arranged and fixed to a pillar frame installed on an upper frame.

The pillar frame may include a first frame having a lower end that is mounted on the upper frame, and an inner surface on which a pair of first fixing pieces, that are fixed to an outer surface of one end portion of the electro hydraulic actuator, are formed to face each other; and second and third frames having lower ends that are mounted on the upper frame to face the first frame, and inner surfaces on which second and third fixing pieces, that are fixed to an outer surface of the other end portion of the electro hydraulic actuator, are formed.

The pillar frame may include a first frame having a lower end that is mounted on the upper frame, and an inner surface on which a pair of first fixing pieces, that are fixed to an outer surface of one end portion of the electro hydraulic actuator, are formed to face each other; and a second frame having a lower end that is mounted on the upper frame to face the first frame, and an inner surface on which a pair of second fixing pieces, that are fixed to an outer surface of the other end portion of the electro hydraulic actuator, are formed to face each other.

The pillar frame may be formed on lower end portions of the first frame and the second and third frames, and may include mounting plates installed on the upper frame by bolts.

The electro hydraulic actuator mounting structure according to an embodiment of the present invention may further include a plurality of blocks which are connected to one side of the hydraulic pumps for the boom, the arm, and the bucket and to which hydraulic hoses are connected to transport hydraulic fluid that is discharged from the hydraulic pumps for the boom, the arm, and the bucket to a boom cylinder, an arm cylinder, and a bucket cylinder.

The electro hydraulic actuator mounting structure according to an embodiment of the present invention may further include converters installed on the upper frame to be adjacent to the electro hydraulic actuators for the boom, the arm, and the bucket to control the electric motors for the boom, the arm, and the bucket.

The converters may be arranged on upper and lower portions of a frame that is mounted on the upper frame so as to correspond to upper and lower positions of the electro hydraulic actuators for the boom, the arm, and the bucket that are mounted on the pillar frame.

The electro hydraulic actuators for the boom, the arm, and the bucket may be arranged between a cabin installed on the upper frame and the converters.

### ADVANTAGEOUS EFFECT

According to the present invention having the above-described configuration, since the electro hydraulic actuators are vertically arranged on the upper frame, utility of a peripheral space can be increased, and the electro hydraulic actuators can be stably mounted on the upper frame.

Further, since the electro hydraulic actuators are mounted in one place, assembling performance and maintainability can be improved, and the occurrence of the electric noise due to the high-voltage cables that connect the electro hydraulic actuators and converters to each other can be reduced.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a view illustrating a state where an electro hydraulic actuator for a hybrid construction machine according to a preferred embodiment of the present invention is mounted on an upper frame;

FIG. 2 is a view illustrating a state where the electro hydraulic actuator of FIG. 1 and a pillar frame for mounting the electro hydraulic actuator on an upper frame are coupled to each other; and

FIG. 3 is a view explaining fixture of the electro hydraulic actuator of FIG. 2 to a pillar frame.

### *EXPLANATION OF REFERENCE NUMERALS FOR MAIN PARTS IN THE DRAWING

1: electric motor for a boom
2: electric motor for an arm
3: electric motor for a bucket
4: hydraulic pump for a boom
5: hydraulic pump for an arm
6: hydraulic pump for a bucket
7: electro hydraulic actuator for a boom
8: electro hydraulic actuator for an arm
9: electro hydraulic actuator for a bucket
10: upper frame
11, 12: first fixing piece
13: first frame
14: second fixing piece
15: third fixing piece
16: second frame
17: third frame
18, 19, 20: block

### DETAILED DESCRIPTION OF THE INVENTION

Hereinafter, an electro hydraulic actuator mounting structure for a hybrid construction machine according to a preferred embodiment of the present invention will be described in detail with reference to the accompanying drawings.

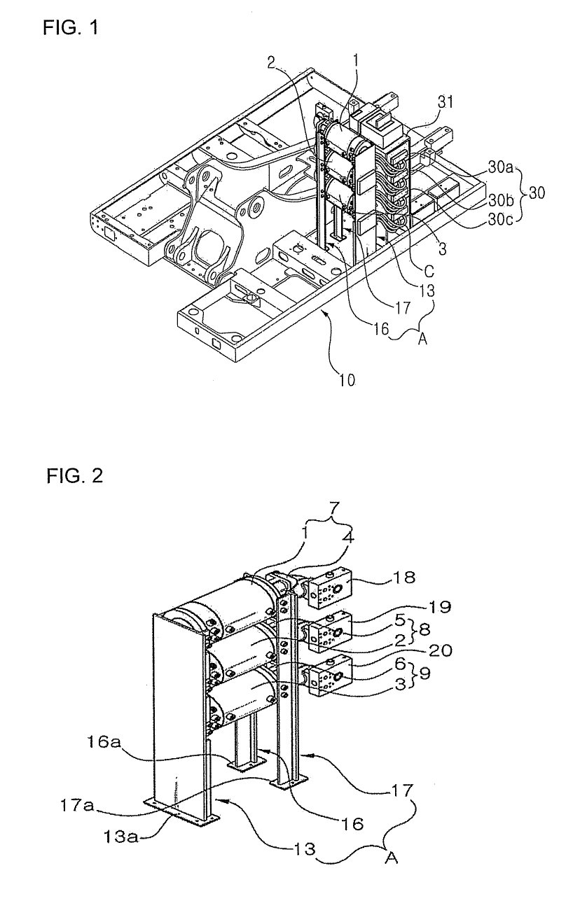

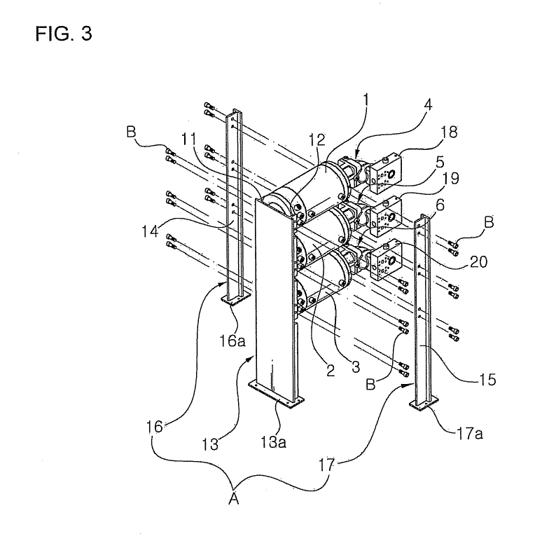

FIG. 1 is a view illustrating a state where an electro hydraulic actuator for a hybrid construction machine according to a preferred embodiment of the present invention is mounted on an upper frame. FIG. 2 is a view illustrating a state where the electro hydraulic actuator of FIG. 1 and a pillar frame for mounting the electro hydraulic actuator on an upper frame are coupled to each other, and FIG. 3 is a view explaining fixture of the electro hydraulic actuator of FIG. 2 to a pillar frame.

Referring to FIGS. 1 to 3, an electro hydraulic actuator for a hybrid construction machine according to an embodiment of the present invention includes electro hydraulic actuators 7, 8, and 9 for a boom, an arm, and a bucket, which include electric motors 1, 2, and 3 for the boom, the arm, and the bucket, that are driven by electric energy which is generated by a generator (not illustrated) that is connected to an engine (not illustrated) and is charged in a battery (not illustrated), and hydraulic pumps 4, 5, and 6 connected to the respective electric motors 1, 2, and 3 for the boom, the arm, and the bucket, wherein the electro hydraulic actuators 7, 8, and 9 for the boom, the arm, and the bucket (that are mounted in a vertical direction) are vertically arranged and fixed to a pillar frame A (that is preferably formed of a steel material) that is mounted on an upper frame 10.

The pillar frame A: 13, 16, and 17 may include a first frame 13 having a lower end that is mounted on the upper frame 10, and an inner surface on which a pair of first fixing pieces 11 and 12, that are fixed to an outer surface of one end portion of each of the electro hydraulic actuators 7, 8, and 9, are formed to face each other; and second and third frames 16 and 17 having lower ends that are mounted on the upper frame 10 to face the first frame 13, and inner surfaces on which second and third fixing pieces 14 and 15, that are fixed to an outer surface of the other end portion of each of the electro hydraulic actuators 7, 8, and 9, are formed.

Although not illustrated in the drawings, the pillar frame A may include a first frame having a lower end that is mounted on the upper frame 10, and an inner surface on which a pair of first fixing pieces, that are fixed to an outer surface of one end portion of each of the electro hydraulic actuators 7, 8, and 9, are formed to face each other; and a second frame having a lower end that is mounted on the upper frame 10 to face the first frame, and an inner surface on which a pair of second fixing pieces, that are fixed to an outer surface of the other end portion of each of the electro hydraulic actuators 7, 8, and 9, are formed to face each other.

The pillar frame A may be formed on lower end portions of the first frame 13 and the second and third frames 16 and 17 by welding, and may include mounting plates 13a, 16a, and 17a installed on the upper frame 10 by bolts.

The electro hydraulic actuator mounting structure according to an embodiment of the present invention may further include a plurality of blocks 18, 19, and 20 which are connected to one side of the hydraulic pumps 4, 5, and 6 for the boom, the arm, and the bucket and to which hydraulic hoses (not illustrated) are connected to transport hydraulic fluid that is discharged from the hydraulic pumps 4, 5, and 6 for the boom, the arm, and the bucket to a boom cylinder, an arm cylinder, and a bucket cylinder.

The electro hydraulic actuator mounting structure according to an embodiment of the present invention may further include power electronic converters (PECs) 30 installed on the upper frame 10 to be adjacent to the electro hydraulic actuators 7, 8, and 9 for the boom, the arm, and the bucket and connected to the electric motors 1, 2, and 3 for the boom, the arm, and the bucket through power cables to control the electric motors 1, 2, and 3 for the boom, the arm, and the bucket.

The converters 30 may be arranged on upper and lower portions of a frame 31 that is mounted on the upper frame 10 so as to correspond to upper and lower positions of the electro hydraulic actuators 7, 8, and 9 for the boom, the arm, and the bucket that are mounted on the pillar frame A.

That is, in the case where the electric motor 1 for the boom is mounted at an upper end of the pillar frame A, a converter 30a for the boom may be mounted on an upper side of the frame 31 to control the electric motor 1 for the boom. In the case where the electric motor 2 for the arm is mounted on a middle side of the pillar frame A, a converter 30b for the arm may be mounted on a middle side of the frame 31 to control the electric motor 2 for the arm. In the case where the electric motor 3 for the bucket is mounted at a lower end of the pillar frame A, a converter 30c for the bucket may be mounted on a lower side of the frame 31 to control the electric motor 3 for the bucket.

The electro hydraulic actuators 7, 8, and 9 for the boom, the arm, and the bucket may be arranged between a cabin (not illustrated) installed on the upper frame 10 and the converters 30.

According to the above-described configuration, the first frame 13 is mounted on the upper frame 10 through bolt-fastening of the mounting plates 13a welded to a lower end portion of the first frame 13, and the second and third frames 16 and 17 are mounted on the upper frame 10 to face the first frame 13 through bolt-fastening of the mounting plates 16a and 17a thereof.

One end portion of each of the electric motors 1, 2, and 3 of the electro hydraulic actuators 7, 8, and 9 for the boom, the arm, and the bucket is inserted between the first fixing pieces 11 and 12 of the first frame 13, and the other end portion of each of the electric motors 1, 2, and 3 is inserted between the second and third fixing pieces 14 and 15 of the second and third frames 16 and 17.

Accordingly, by bolts B that penetrate mounting holes of a pair of first fixing pieces 11 and 12 formed on the inner surface of the first frame 13, the outer surface of one end portion of each of the electric motors 1, 2, and 3 for the boom, the arm, and the bucket is fixed. In this case, the bolts B are inserted into the mounting holes of the first fixing pieces 1 land 12 and are fastened to screw holes formed on the outer surfaces of the electric motors 1, 2, and 3 for the boom, the arm, and the bucket.

Further, by bolts B that penetrate mounting holes of the second and third fixing pieces 14 and 15 formed on the inner surfaces of the second and third frames 16 and 17, the outer surface of the other end portion of each of the electric motors 1, 2, and 3 for the boom, the arm, and the bucket is fixed. In this case, the bolts B are inserted into the mounting holes of the second and third fixing pieces 14 and 15 and are fastened to screw holes formed on the outer surfaces of the electric motors 1, 2, and 3 for the boom, the arm, and the bucket.

Accordingly, the electro hydraulic actuators 7, 8, and 9 for the boom, the arm, and the bucket, which are fixed by the pillar frame A: 13, 16, and 17 mounted on the upper frame 10 are vertically arranged. As described above, since the electro hydraulic actuators 7, 8, and 9 for the boom, the arm, and the bucket are arranged and mounted in the vertical direction, utility of a peripheral space can be increased, and assembling performance and maintainability of the electro hydraulic actuators 7, 8, and 9 can be improved.

Further, the converters 30 that can control the electric motors 1, 2, and 3 are mounted beside the electro hydraulic actuators 7, 8, and 9 for the boom, the arm, and the bucket. Through this, the length of power cables C that connect the converters 30 and the electric motors 1, 2, and 3 to each other can be reduced. Further, since the high-voltage cables C that are connected to the electric motors 1, 2, and 3 can be gathered in one place to be isolated, the occurrence of electric noise due to the high-voltage cables C can be reduced.

On the other hand, since the technical features to charge the electric energy that is generated by the generator connected to the engine in the charging device, to drive the electric motors 1, 2, and 3 for the boom, the arm, and the bucket using the charged electric energy, and to control the flow rate of the hydraulic fluid that is supplied from the hydraulic pumps 4, 5, and 6 for the boom, the arm, and the bucket to the boom cylinder, the arm cylinder, and the bucket cylinder through control of the electric motors 1, 2, and 3 are known in the field of the hybrid construction machine, the detailed explanation thereof will be omitted.

Although the invention has been described with reference to the preferred embodiments in the attached figures, it is noted that equivalents may be employed and substitutions made herein without departing from the scope of the invention as recited in the claims.

### INDUSTRIAL APPLICABILITY

According to the present invention having the above-described configuration, since the electro hydraulic actuators that can control the boom, the arm, and the bucket using the electric energy are vertically mounted on the upper frame, the peripheral space can be usefully used.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

What is claimed is:

1. An electro hydraulic actuator mounting structure for a hybrid construction machine, comprising:
electro hydraulic actuators for a boom, an arm, and a bucket, which include electric motors for the boom, the arm, and the bucket, that are driven by electric energy generated by a generator that is connected to an engine, and a plurality of hydraulic pumps connected to the respective electric motors for the boom, the arm, and the bucket,
wherein the electro hydraulic actuators for the boom, the arm, and the bucket are vertically arranged and fixed to a pillar frame installed on an upper frame.

2. The electro hydraulic actuator mounting structure according to claim 1, wherein the pillar frame comprises:
a first frame having a lower end that is mounted on the upper frame, and an inner surface on which a pair of first fixing pieces, that are fixed to an outer surface of one end portion of the electro hydraulic actuator, are formed to face each other; and
second and third frames having lower ends that are mounted on the upper frame to face the first frame, and inner surfaces on which second and third fixing pieces, that are fixed to an outer surface of the other end portion of the electro hydraulic actuator, are formed.

3. The electro hydraulic actuator mounting structure according to claim 1, wherein the pillar frame comprises:
a first frame having a lower end that is mounted on the upper frame, and an inner surface on which a pair of first fixing pieces, that are fixed to an outer surface of one end portion of the electro hydraulic actuator, are formed to face each other; and
a second frame having a lower end that is mounted on the upper frame to face the first frame, and an inner surface on which a pair of second fixing pieces, that are fixed to an outer surface of the other end portion of the electro hydraulic actuator, are formed to face each other.

4. The electro hydraulic actuator mounting structure according to claim 2, wherein the pillar frame is formed on lower end portions of the first frame and the second and third frames, and is composed of mounting plates installed on the upper frame by bolts.

5. The electro hydraulic actuator mounting structure according to claim 1, further comprising a plurality of blocks which are connected to one side of the hydraulic pumps for the boom, the arm, and the bucket and to which hydraulic hoses are connected to transport hydraulic fluid that is discharged from the hydraulic pumps for the boom, the arm, and the bucket to a boom cylinder, an arm cylinder, and a bucket cylinder.

6. The electro hydraulic actuator mounting structure according to claim 1, further comprising converters installed on the upper frame to be adjacent to the electro hydraulic actuators for the boom, the arm, and the bucket to control the electric motors for the boom, the arm, and the bucket.

7. The electro hydraulic actuator mounting structure according to claim 6, wherein the converters are arranged on upper and lower portions of a frame that is mounted on the upper frame so as to correspond to upper and lower positions of the electro hydraulic actuators for the boom, the arm, and the bucket that are mounted on the pillar frame.

8. The electro hydraulic actuator mounting structure according to claim 6, wherein the electro hydraulic actuators for the boom, the arm, and the bucket are arranged between a cabin installed on the upper frame and the converters.
